(19) United States
(12) Patent Application Publication
(10) Pub. No.: US 2011/0083161 A1
(43) Pub. Date: Apr. 7, 2011

(54) VEHICLE, MAINTENANCE DEVICE, MAINTENANCE SERVICE SYSTEM, AND MAINTENANCE SERVICE METHOD

(76) Inventors: Takayuki Ishida, Kanagawa (JP); Masayuki Hirokawa, Kanagawa (JP); Kazuo Tashiro, Kanagawa (JP)

(21) Appl. No.: 12/996,156

(22) PCT Filed: Jun. 4, 2008
(86) PCT No.: PCT/JP2008/060280

§ 371 Date: Dec. 3, 2010

(51) Int. Cl. G06F 21/00

(52) U.S. Cl. 726/2

(57) ABSTRACT

The vehicle includes electronic control units, and performs an authentication process to judge the validity of an external device outside the vehicle, e.g. a maintenance device, which tries accessing the electronic control unit. Based on the result of the judgment, the vehicle decides a range in which the maintenance device can access the electronic control unit. In the authentication, e.g. both the maintenance device and the vehicle use authentication microcomputers respectively. According to the invention, an external device outside the vehicle can be inhibited from making an unwanted access to the electronic control unit of the vehicle.

### FIELD OF THE INVENTION

The present invention relates to a technique for authenticating a vehicle and its maintenance device, which is useful in application to e.g. a maintenance service of an automobile.

### BACKGROUND OF THE INVENTION

Conventionally, security measures have been taken in terms of data protection and the like in various fields of e.g. (1) ID cards, (2) credit cards, (3) network authentication, and (4) protection of video and music contents. The means adopted as these security measures are e.g. use of a password, transmission/receipt using encrypted data, and authentication by use of a means, such as holding of an IC card and the like. However, the leakage of password and cipher key, the theft of an IC card or other causes can easily break a security system. Therefore, how to build a tight security system is a challenge. Particularly, in a field directly involving human lives, a tighter security tends to be required.

There are cases in a consumer-use field, in which a tight security authentication chip—an authentication microcomputer—is used for e.g. authentication of a battery, and an accessory for a digital device. The level of security achieved in such cases is that the devices authenticate each other, at the highest. Techniques used for such level of security are described in e.g. Japanese Unexamined Patent Publications JP-A-2005-151368 and JP-A-2004-310387.

Examples of known automobile-related authentication techniques are as follows. Japanese Unexamined Patent Publication JP-A-2007-214696 discloses a technique for authentication between electronic control units which share a on-vehicle network of an automobile. Further, Japanese Unexamined Patent Publication JP-A-2007-66116 describes a technique characterized in that the maintenance information of an automobile is shared by a client, a maintenance shop and a leasing company through a network, and the security of the network is ensured by authentication. Besides, Japanese Unexamined Patent Publication JP-A-2003-046536 discloses a technique for performing an authentication between an on-vehicle LAN of an automobile and an external device outside it and then establishing a communication therebetween. None of the patent documents concerning the automobile-related techniques involves the idea performing an authentication process by use of an authentication microcomputer.

### SUMMARY OF THE INVENTION

In recent years, the number of ECUs (Electronic Control Units) mounted on automobiles have been increasing, and there has been the growing trend of electronically controlling automobiles. In keeping with this trend, important parts including an engine, a brake, an air bag, and a speed limiter are under the control of ECUs, and a failure or an accident involving human lives are caused by an overwrite of an ECU program, which an automobile manufacturer did not intend. Such failure or accident may lead to a lawsuit against an automobile manufacturer because when and where an ECU program in question was changed cannot be identified. On this account, a means for preventing an unauthorized overwrite on an ECU program, and a technique for identifying when and where a change was made on the program have been desired. About these circumstances, no considerations were made in the references cited above.

It is an object of the invention to provide a technique for inhibiting an unwanted access to an electronic control unit of a vehicle from a device outside it.

It is another object of the invention to provide a technique which can readily realize a high-level security management for an electronic control unit of a vehicle.

The above and other object of the invention, and novel features thereof will be apparent from the description hereof and the accompanying drawings.

Now, of preferred embodiments herein disclosed, representative one will be described below.

According to the embodiment, a vehicle performs an authentication process thereby to judge the validity of an external device, e.g. a maintenance device, which makes an access to an electronic control unit of the vehicle from outside. According to the result of the judgment, the vehicle decides a range in which the maintenance device is allowed to access the electronic control unit. In authentication, microcomputers for authentication are used on both the maintenance device and vehicle respectively, for example.

The effects achieved by the vehicle according to the above embodiment are as follows in brief.

According to the invention, the vehicle is arranged to authenticate an external device outside it. As a result, it becomes possible to inhibit the external device from making an unwanted access to an electronic control unit of a vehicle.

By using an authentication microcomputer to perform a required authentication, it becomes easier to realize a high-level security management for an electronic control unit of a vehicle.

### BRIEF DESCRIPTION OF THE DRAWINGS

FIG. 1 is a block diagram showing an example of the configuration of an interface portion of an externally-connecting electronic control unit and a maintenance device;

FIG. 2 is a block diagram showing an example of the configuration of an automobile, in which electronic control units are highlighted;

FIG. 3 is a diagram for explaining security levels corresponding to ID numbers of authentication chips, hereinafter referred to as “authentication chip ID numbers”;

FIG. 4 is a flow chart showing an example of the basic flow of an authentication process between the automobile and maintenance device;

FIG. 5 is a flow chart showing an example of the basic flow of an authentication process between an automobile and a maintenance device without the authentication chips, which is for comparison to the example of FIG. 4;

FIG. 6 is a flow chart more concretely showing the process steps of the authentication process described with reference to FIG. 4;

FIG. 7 is a block diagram showing an example of the basic form of a maintenance service system including a maintenance device and an online server of an automobile manufacturer;

FIG. 8 is a flow chart showing a concrete example of an authentication process in the maintenance service system;

FIG. 9 is a block diagram showing an example in which the authentication chip is incorporated in each of ECUs of the automobile; and

FIG. 10 is a flow chart showing an example of the authentication processing method using the authentication chips of each ECU.

### 1. DETAILED DESCRIPTION OF THE PREFERRED EMBODIMENTS

First, the preferred embodiments of the invention herein disclosed will be outlined. Here, the reference numerals, and characters to refer to the drawings, which are accompanied with paired round brackets, only exemplify what the concepts of constituent parts or members referred to by the numerals, and characters contain.

[1] A vehicle according to one preferred embodiment of the invention includes: a plurality of electronic control units (10-13, 20-22, 3-31) arranged to electronically control an action of the vehicle; an on-vehicle network (15, 23, 32) with the electronic control units connected thereto; and an externally-connecting electronic control unit (40) operable to interface the on-vehicle network to a maintenance device (60) outside the vehicle. The externally-connecting electronic control unit performs an authentication process on the maintenance device in order to decide a range in which the maintenance device is allowed to access the electronic control unit.

From the viewpoint of a particular vehicle, a wide variety of maintenance devices, including maintenances devices held by an appropriate authorized dealer, a partner dealer, and other service shops, are allowed to access an electronic control unit thereof. Even under the circumstances like this, the vehicle authenticates each maintenance device, and therefore it is possible to inhibit a maintenance device from making an unwanted access to an electronic control unit of the vehicle.

[2] In regard to the vehicle as described in [1], the externally-connecting electronic control unit has an authentication microcomputer (400) for performing the authentication process, and the authentication microcomputer performs the authentication process on an authentication microcomputer (600) mounted on the maintenance device. As the authentication microcomputers mounted on the vehicle and the maintenance device are used to conduct the authentication process, it is possible to build a security system firmer and less vulnerable to a physical attack, an information leak attack and a malfunction attack. The use of the authentication microcomputers enables the generation of random numbers, and the use of the public key cryptosystem. Therefore, the impersonation which can be conducted by means of copy of a system or LSI through a software program can be prevented by mutual authentication of the authentication microcomputers. Further, by devising the way of distributing cipher keys, and the means for managing parameters, ID numbers, etc., it becomes possible to impart more than one security level to a device to be authenticated. By assigning more than one security level to the device to be authenticated, it becomes possible to restrict a range of access from the device to be authenticated (maintenance device) to the authenticating device (vehicle) according to the security level. Hence, the performance of maintenance of the automobile can be increased by the following procedure including: restricting a range of access to LSI through authentication microcomputers as referred to as “secure authentication chips”; using the authentication microcomputers to encrypt an access history, i.e. log; and saving the history in a nonvolatile memory inside the vehicle.

[3] In regard to the vehicle as described in [2], the electronic control units each have an authentication microcomputer (100), and the authentication microcomputer mounted on the electronic control unit performs an authentication process on an authentication microcomputers mounted on another electronic control units in order to judge validity thereof. According to this arrangement, the impersonation by means of an unauthorized copy of LSI can be prevented.

[4] In regard to the vehicle as described in [3], the authentication microcomputers (100) mounted on the electronic control units start the authentication process in response to power-on of operating power. According to this arrangement, it is possible to watch for a suspicious sign of impersonation each time the power is turned on.

[5] In regard to the vehicle as described in [1], the externally-connecting electronic control unit decides a range of access to be restricted, based on an ID code provided by the maintenance device connected thereto, after having checked validity of the maintenance device by the authentication process. According to this arrangement, a secure level control can be achieved with ease using ID codes.

[6] The vehicle as described in [5] further includes a memory (70, 402) for holding a history of maintenance by the maintenance device, wherein the memory is targeted for control of the access range according to a result of the authentication process. According to this arrangement, the maintenance history information can be encrypted and held in the vehicle while keeping the security ensured. Therefore, the management of maintenance history information is made easier.

[7] From another aspect of the invention, a vehicle according to one preferred embodiment thereof includes: a plurality of electronic control units arranged to electronically control an action of the vehicle; an on-vehicle network connected with the electronic control units; and an externally-connecting electronic control unit operable to interface the on-vehicle network to a maintenance device outside the vehicle, wherein the externally-connecting electronic control unit has an authentication microcomputer, and the authentication microcomputer performs an authentication process on the maintenance device in order to decide whether or not to permit the maintenance device to access the electronic control unit.

[8] From another aspect of the invention, a vehicle according to one preferred embodiment thereof includes: a plurality of electronic control units arranged to electronically control an action of the vehicle; an on-vehicle network connected with the electronic control units; and an externally-connecting electronic control unit for interfacing the on-vehicle network to an external device outside the vehicle, wherein the externally-connecting electronic control unit performs an authentication process on the external device outside the vehicle in order to decide whether or not to permit the external device to access the electronic control unit.

[9] A maintenance device according to one preferred embodiment of the invention is for supporting maintenance of a vehicle having a plurality of electronic control units operable to electrically control an action of the vehicle, and has: an authentication microcomputer connectable with an externally-connecting electronic control unit of the vehicle; and a microcomputer operable to control the maintenance support. In the maintenance device, the authentication microcomputer and the externally-connecting electronic control unit connected therewith perform an authentication process on each other. Further, a range in which the microcomputer operable to control the maintenance support can access the electronic control unit of the vehicle is decided according to a result of the authentication process by the externally-connecting electronic control unit.

According to this arrangement, an electronic control unit of the vehicle which the maintenance device deals with can be prevented from being accessed by another maintenance device based on a security system different from that adopted for the maintenance device associated with the invention.

[10] In regard to the maintenance device as described in [9], the authentication microcomputer sends a result of a judgment on validity of the vehicle connected therewith to the microcomputer operable to control the maintenance support. According to this arrangement, it is possible to readily eliminate the unproductiveness that the maintenance device tries to access the electronic control unit against the vehicle restriction on an electronic control unit thereof.

[11] A maintenance service system according to one preferred embodiment of the invention has: a maintenance device for supporting maintenance of a vehicle having a plurality of electronic control units operable to electrically control an action of the vehicle; and an online server (90) operable to manage maintenance information of the vehicle. The maintenance device is allowed to access maintenance information in the online server on condition that the vehicle, maintenance device and online server have been authenticated as results of authentication processes between the vehicle and maintenance device, between the maintenance device and online server, and between the online server and vehicle. A range in which the maintenance device can access the electronic control unit of the vehicle is decided according to a result of the authentication process between the vehicle and maintenance device.

According to this arrangement, it is possible to inhibit the maintenance device from making an unwanted access to an electronic control unit of the vehicle, as in the vehicle described above. In addition, the management of maintenance history information can be centralized by the online server while the security is ensured.

[12] In regard to the maintenance service system as described in [11], the maintenance device has an authentication microcomputer (600A) for performing a mutual authentication process between the maintenance device and online server. Further, the online server is paired with an authentication microcomputer (400A) of the vehicle, and the online server and authentication microcomputer perform an authentication process on each other. In addition, the authentication microcomputer of the maintenance device is paired with the authentication microcomputer of the vehicle, and the authentication microcomputers perform an authentication process on each other.

[13] A maintenance service method according to one preferred embodiment of the invention is a method of using a maintenance device for supporting maintenance of a vehicle having a plurality of electronic control units operable to electrically control an action of the vehicle, and an online server operable to manage maintenance information of the vehicle, and which includes: a first step of performing an authentication process between the vehicle and maintenance device; a second step of performing an authentication process between the maintenance device and online server; a third step of performing an authentication process between the online server and vehicle; a fourth step of accessing maintenance information of the online server by the maintenance device on condition that the vehicle and maintenance device, and online server have been authenticated as results of the first to third steps; and a fifth step of accessing the electronic control unit of the vehicle by the maintenance device in a range determined according to a result of the authentication process between the maintenance device and vehicle.

According to this arrangement, it is possible to inhibit the maintenance device from making an unwanted access to an electronic control unit of the vehicle, as in the maintenance service system described above. In addition, the management of maintenance history information can be centralized by the online server while the security is ensured.

[14] In regard to the maintenance service method as described in [13], the maintenance device includes an authentication microcomputer for performing a mutual authentication process between the maintenance device and online server. Further, the online server performs an authentication process between the online server and an authentication microcomputer mounted on the automobile. In addition, the authentication microcomputer of the maintenance device performs an authentication process between the authentication microcomputer of the maintenance device and the authentication microcomputer mounted on the automobile.

### 2. FURTHER DETAILED DESCRIPTION OF THE PREFERRED EMBODIMENTS

While the preferred embodiments of the invention will be described here further in detail, the detailed descriptions will be presented below with reference to the drawings. It is noted that as to all the drawings to which reference is made in describing the embodiments, the constituents or elements having identical functions are identified by the same reference numeral, and the repeated description thereof is omitted here.

### <<Automobile>>

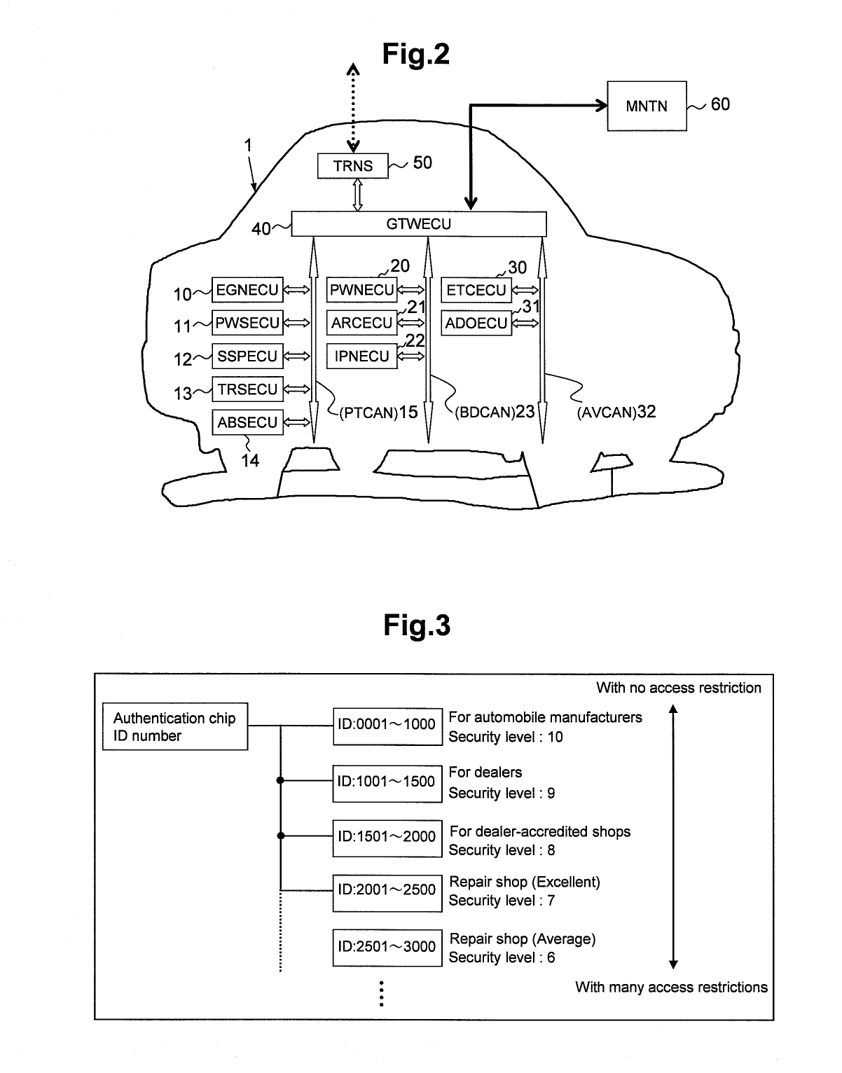

FIG. 2 shows an example of the configuration of an automobile 1, in which electronic control units are highlighted. The electronic control unit (ECU) is a control circuit for electronically controlling the action of an automobile. The electronic control units 10-14, and other parts involved therein are provided for controlling e.g. drive and chassis systems of the automobile, and connected to an on-vehicle network (PTCAN) 15 for the systems. The electronic control units 20-22 and other parts involved therein are provided for controlling a body system of the automobile, and connected to an on-vehicle network (BDCAN) 23 for the body system. The electronic control units 30-31 and other parts involved therein are provided for controlling an audio-video system of the automobile, and connected to an on-vehicle network (AVCAN) 32 for the audio-video system. The externally-connecting electronic control unit (GTWECU) 40 is provided for interfacing the on-vehicle networks 15, 23 and 32 with a device outside the automobile.

The electronic control unit (EGNECU) 10 is designed for engine control, and serves to control a throttle valve, an air valve and the like in the engine. The electronic control unit (PWSECU) 11 is for control of a power steering. The electronic control unit (SSPECU) 12 is for suspension control. The electronic control unit (TRSECU) 13 is for transmission control. The electronic control unit (ABSECU) 14 is for ABS control. The electronic control unit 20 (PWNECU) is for power window control. The electronic control unit (ARCECU) 21 is for control of an air conditioner. The electronic control unit (INPECU) 22 is for instrument panel control. The electronic control unit (ETCECU) 30 is for ETC control. The electronic control unit (ADOECU) 31 is for control of an audio and the like. While not shown in the drawing, a safety system such as air bag constructs a network, to which the invention is applicable. Each electronic control unit includes CPU and a memory, and offers an intended function under the control of a software program running on CPU.

The on-vehicle networks 15, 23 and 32 are e.g. networks compliant with CAN (Controller Area Network), which is an on-vehicle network protocol standardized as ISO11898.

The externally-connecting electronic control unit (GTWECU) 40 is interfaced with a wireless-communication device 50 which performs a wireless communication according to a mobile or other wireless communication protocol. Also, the electronic control unit 40 can be interfaced with a maintenance device 60 which supports a maintenance of the automobile in a authorized dealer or an automobile repair shop at the time of an automobile inspection or a routine inspection, and in such condition, the electronic control unit 40 performs a gateway control for connection between such external device outside the vehicle and ECU. Particularly, the externally-connecting electronic control unit 40 performs the authentication process on the maintenance device 60 in order to decide a range in which the maintenance device 60 is allowed to access the electronic control units 10-14, 20-22 and 30-31. The significance of authentication of a maintenance device by a vehicle is as follows. An overwrite of an ECU program, which an automobile manufacturer did not intend can cause an accident, and it is difficult to clearly identify when and where the ECU program was changed only from the ECU program. Under the circumstances, the first requirement to reach the first object is to prevent an unauthorized overwrite on ECU. The detail of the authentication process by the vehicle will be described below.

### <<Authentication Chip>>

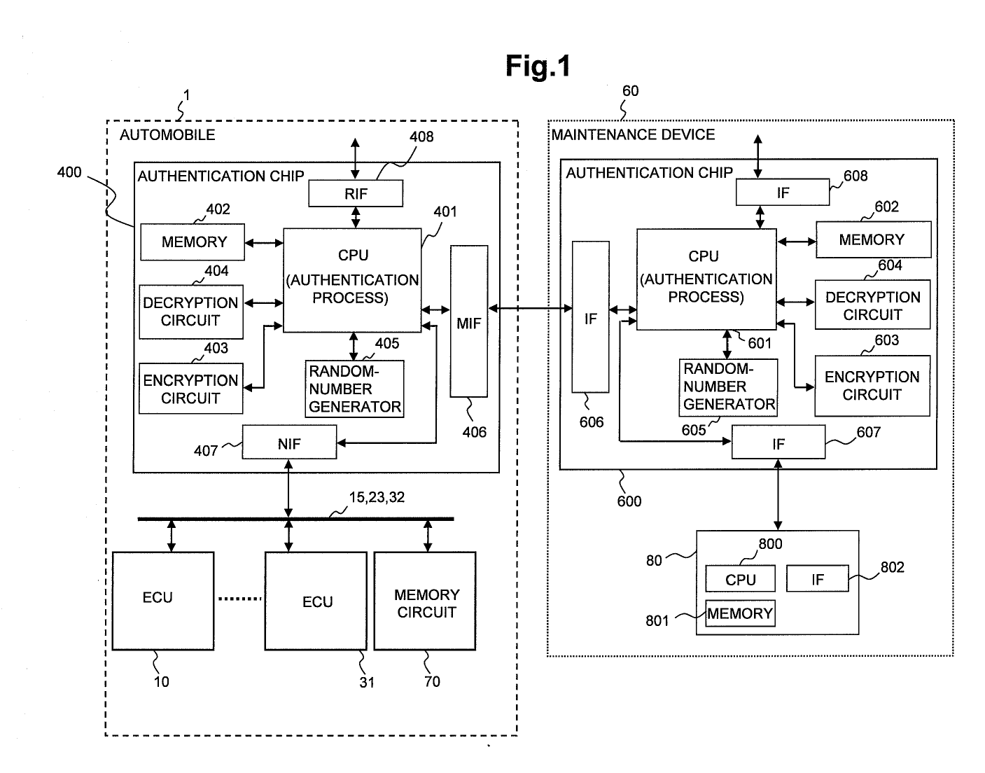

FIG. 1 shows an example of the configuration of an interface portion of the externally-connecting electronic control unit 40 and a maintenance device 60. The externally-connecting electronic control unit 40 in the automobile 1 has an authentication microcomputer 400, which is hereinafter also referred to as “authentication chip”, whereas the maintenance device 60 includes an authentication chip 600. The authentication chips 400 and 600 are each formed as a semiconductor integrated circuit, on which known measures have been taken against: a physical attack in which information is readout from a circuit pattern by a physical destruction, such as exfoliation of a surface protection film; an information leak attack, in which the analysis of electric current or the like is performed; a malfunction attack, in which means for actively causing a malfunction is used. Also, the authentication chips 400 and 600 are generally arranged to be able to conduct steps of a known software program for ensuring the confidentiality and validity by means of the generation of random numbers and public key cryptosystem. In the interface portion, the authentication chips 400 and 600 execute the steps of such software program to authenticate each other, thereby preventing the impersonation and the like which can be conducted by means of copy of a system or LSI through a software program. By using ID numbers to provide the device to be authenticated with more than one security level, it is made possible to restrict the range of access from the device to be authenticated (the maintenance device) to the authenticating device (the vehicle) according to the more than one security level.

The authentication chip 400 has: a CPU (Central Processing Unit) 401; a memory 402 including a volatile memory such as SRAM and a nonvolatile memory such as a flash memory; an encryption circuit 403; a decryption circuit 404 for decrypting a cipher; a random-number generator 405; an interface circuit (MIF) 406 connected to the maintenance device 60; an interface circuit (NIF) 407 connected to the on-vehicle networks 15, 23 and 32; and an interface circuit (RIF) 408 connected to a wireless-communication device. CPU 401 executes a software program held in the memory 402 thereby to perform data processing, such as authentication and data transfer. Although no special restriction is intended, not only ECUs but also a memory circuit 70 is connected to the on-vehicle networks 15, 23 and 32, as a discrete unit. The memory 402 and memory circuit 70 are used to store ECU access histories and the like. The access histories include: an access address which indicates the ECU that was accessed; a time stamp which shows an access time; a program code which makes possible to determine a program subjected to overwrite; and a device ID of the maintenance device which is an agent of access.

The authentication chip 600 has a CPU (Central Processing Unit) 601; a memory 602 including a volatile memory such as SRAM and a nonvolatile memory such as a flash memory; an encryption circuit 603; a decryption circuit 604 for decrypting a cipher; a random-number generator 605; an interface circuit (AIF) 606 connected to the electronic control unit 40 of the automobile 1; an interface circuit (μIF) 607 connected to a microcomputer 80 for maintenance support control; and an interface circuit (OIF) 608. CPU 601 executes a software program held in the memory 602 to perform an authentication and a data processing such as data transfer. Although no special restriction is intended, the microcomputer 80 for maintenance support control has a CPU 800, a memory 801 and an interface circuit 802, and it receives an output of a sensor and input data through a keyboard, both not shown in the drawing, and performs data processing necessary for maintenance of the automobile. Also, the microcomputer 80 overwrites memories which ECU 10-31 of the automobile 1 have, and accesses the memory circuit 70 through the authentication chip 600, as needed.

The authentication chip 600 of the maintenance device 60 is assigned an ID numbers, hereinafter referred to as “authentication chip ID numbers”. As in the example shown in FIG. 3, the ID numbers are classified into groups of ID numbers intended for automobile manufacturers, dealers, dealer-accredited shops, excellent repair shops, and average repair shops, and the groups have different security levels respectively. The security level for automobile manufacturers is #10, which is the highest. The higher the security level is, the fewer the restrictions on access to ECUs of the automobile are made. The maintenance device 60 with the security level #10 can make full access to ECUs of the automobile. In other words, in the example shown in FIG. 1, the maintenance device 60 is allowed to make read and write accesses to the ECUs 10-31 and memory circuit 70 thoroughly. With a device having a security level below LEVEL 10, the full access to all of the ECUs 10-31 and memory circuit 70 can be restricted. From the viewpoint of meeting the first requirement, the authentication chip 400 of the automobile, which is the authenticating device, takes an authentication chip ID number of a maintenance device in the course of the authentication process, and controls the access restrictions based on the authentication chip ID number. Now it is noted that the authentication chip ID number is written into e.g. a nonvolatile memory of a maintenance device before shipment from its manufacturing plant. No special restriction is intended concerning the concrete method of restricting the access. However, the address management for an address targeted for access, specified by an access command that the maintenance device 60 offers may be performed for each security level. For instance, CPU 401 performs such address management according to a software program, and which address management program to use is decided based on the security level taken from the maintenance device 60.

### <<Authentication Process Between the Automobile and Maintenance Device>>

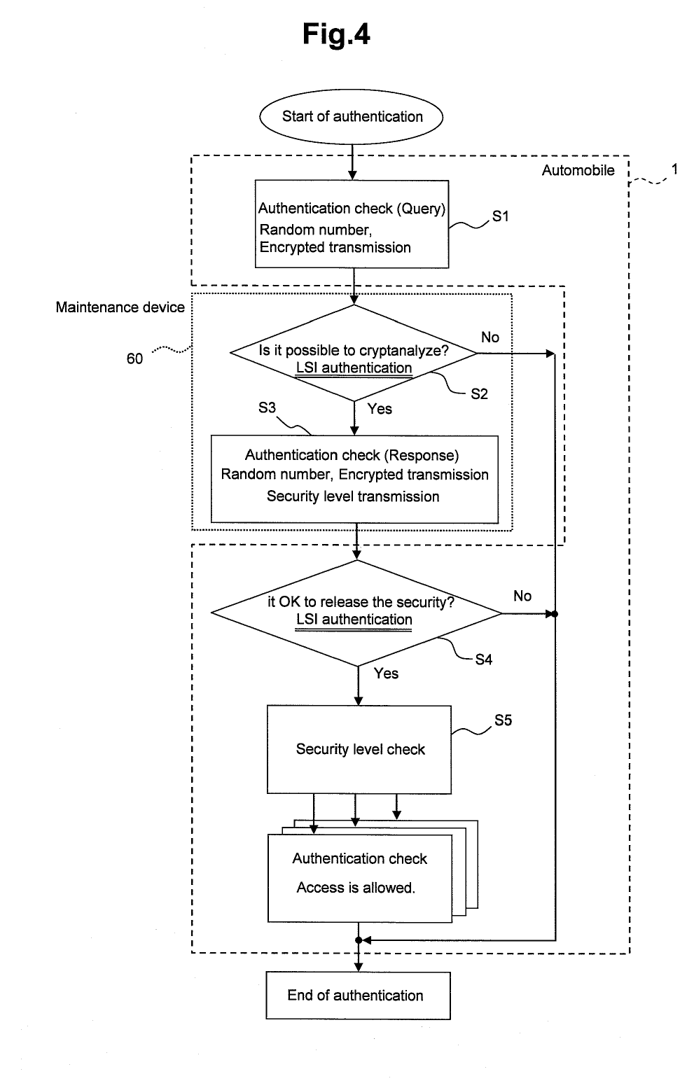

FIG. 4 shows an example of the basic flow of the authentication process between the automobile and maintenance device. On condition that the authentication chip 600 of the maintenance device 60 is connected to the authentication chip 400 of the automobile 1, the authentication chips 400 and 600 try authenticating each other. First, the authentication chip 400 uses the random-number generator 405 and encryption circuit 403 to perform an authentication check (query) for checking whether or not the authentication chip 600 is a proper chip (S1). The authentication check is conducted through the interface circuits 406 and 606 by encrypted communication. For encryption, e.g. a public key cryptosystem is adopted. Subsequently, the authentication chip 600 uses the decryption circuit 604 to perform a decryption for the authentication check (query) (S2). Now, in case that a cipher key for decryption does not fit, the cryptanalysis cannot be done, resulting in the failure in authentication. If the cipher has been decrypted, the authentication chip 600 thereafter uses the random-number generator 605 and encryption circuit 603 to prepare a response to the authentication check (query) and sends the response to the authentication chip 400 (S3). Then, the authentication chip 400 uses the decryption circuit 404 and a cipher key to decrypt the response, thereby to make a check on whether or not the authentication chip 600 is a proper product (S4), and a check on the security level of the authentication chip 600 (S5). If it is verified that the security level is #10, the microcomputer 80 for maintenance support control, which is included in the maintenance device 60, can access the ECUs 10-31 and memory circuit 70 of the automobile. If a security level below the level #10 has been verified, the authentication chip 400 puts restrictions on accesses to the ECUs 10-31 and memory circuit 70 by the microcomputer 80 for maintenance support control. In short, the authentication chip 400 rejects an access request with access restriction, and for example, returns an error code to the sender of the access request instead of transferring the access request in question to the on-vehicle networks 15, 23 and 32. For instance, the authentication chip 400 rejects accesses to ECU 10 and the memory circuit 70 from a maintenance device of an average repair shop with the security level #7.

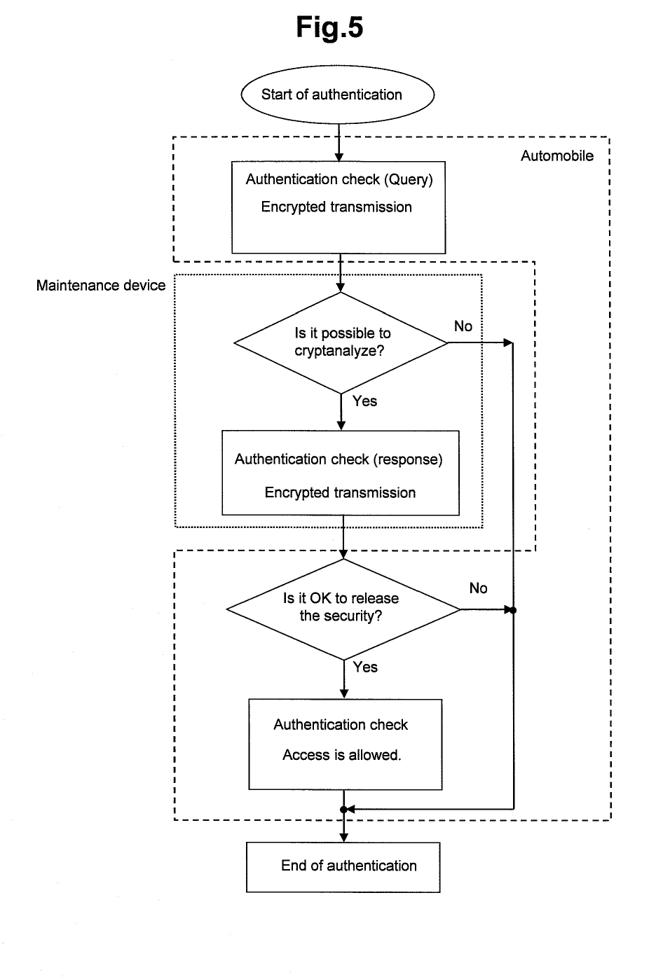

In the example of FIG. 4, the decryption of the query in Step S2 and the decryption of the response in Step S4 are performed using the authentication chips 400 and 600 according to a sturdy authentication scheme, such as the RSA cryptographic scheme. Therefore, it is possible to prevent the impersonation by a substitute chip or copy chip as long as it is not an exact copy of the original one. Besides, it is substantially impossible to analyze and copy an authentication chip. On this account, it is guaranteed that the authentication process is performed with a high reliability. In case that the authentication chips 400 and 600 are not used, the authentication is a process including the steps of simple encryption and decryption, which a software program executes as in the example shown in FIG. 5, and it cannot be expected that the authentication is conducted with a high reliability.

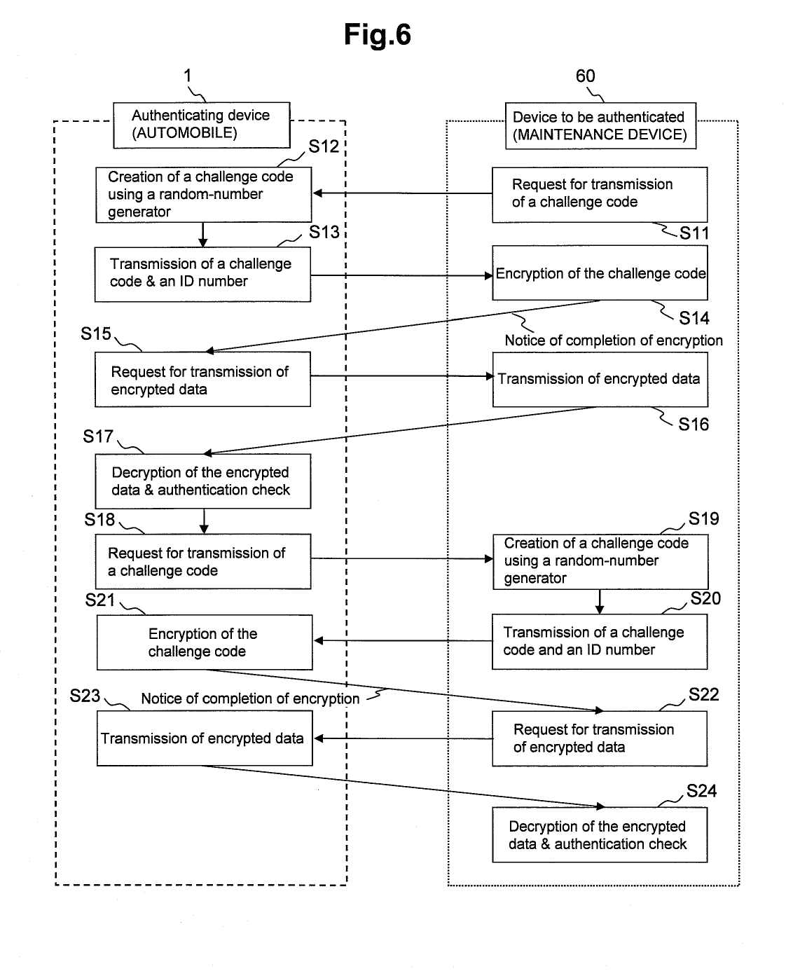

FIG. 6 shows a more concrete example of the authentication process. When the authenticating device (automobile) and the device to be authenticated (maintenance device) are connected with each other, the device to be authenticated issues a request for transmission of a challenge code to the authenticating device (S11). It is noted that the challenge code refers to a character string created by a random-number generator. On receipt of the request for transmission of a challenge code, the authenticating device uses the random-number generator 405 to generate a challenge code (S12), and transmits the code to the device to be authenticated (S13). In the step of the transmission, the authenticating device concurrently transmits data, such as an ID number of the authentication chip 400 carried by the automobile, as required. Subsequently, the device to be authenticated receives the challenge code, and then uses the encryption circuit 603 thereof to encrypt the challenge code (S14). Then, the device to be authenticated responds to a request for transmission from the authenticating device (S15) to transmit the encrypted challenge code to the authenticating device (S16). Thereafter, the authenticating device uses a cipher key to decrypt the encrypted challenge code, and makes a judgment on whether or not the challenge code which the authenticating device transmitted agrees with the decrypted one. If the challenge codes agree with each other, the authenticating device judges that the device to be authenticated is proper, and then authenticates the device to be authenticated (S17).

Next, the authenticating device issues a request for transmission of a challenge code to the device to be authenticated (S18), followed by execution of Steps S19 to S24, which are the same as Steps S12 to S17. In this way, mutual authentication by the authentication chips 400 and 600 is completed. Particularly, the ID number output in Step S20 is the authentication chip ID number of the authentication chip 600 of the maintenance device described with reference to FIG. 3. In Step S11, the authentication chip 400 determines the security level of the authentication chip 600 based on the authentication chip ID number, which the authentication chip 400 received from the authentication chip 600, and based on the security level, the authentication chip 400 as the authenticating device grasps an allowable range of access from the maintenance device 60. It is noted that the authentication chip ID number of the authentication chip 600 may be encrypted in Step S14 and transmitted in Step S16, together with a challenge code, and then used to determine the security level in Step S17.

On condition that the automobile and maintenance device each include an authentication chip and the automobile authenticates the maintenance device, overwrite and access to ECU, which an improper maintenance device performs can be rejected. Also, the range in which a maintenance device can access ECUs can be restricted to a particular one according to the security level of the authentication chip incorporated in the maintenance device. Therefore, a range accessible only for an automobile dealer, a range accessible for a repair shop, and the like can be discriminated, and further a range of authority to perform an overwrite on an ECU, and a range of access to a maintenance history written into a memory can be restricted. Thus, a change of an ECU program and the like, which an automobile manufacturer did not intend, can be prevented. In addition, keeping data of the shipping destination of a secure authentication chip incorporated in a maintenance device under management, it is possible to know when, where and by whom a change to a software program of ECU carried by the automobile, an access to a data region, and the like are made.

### <<Authentication Process in a Maintenance Service System>>

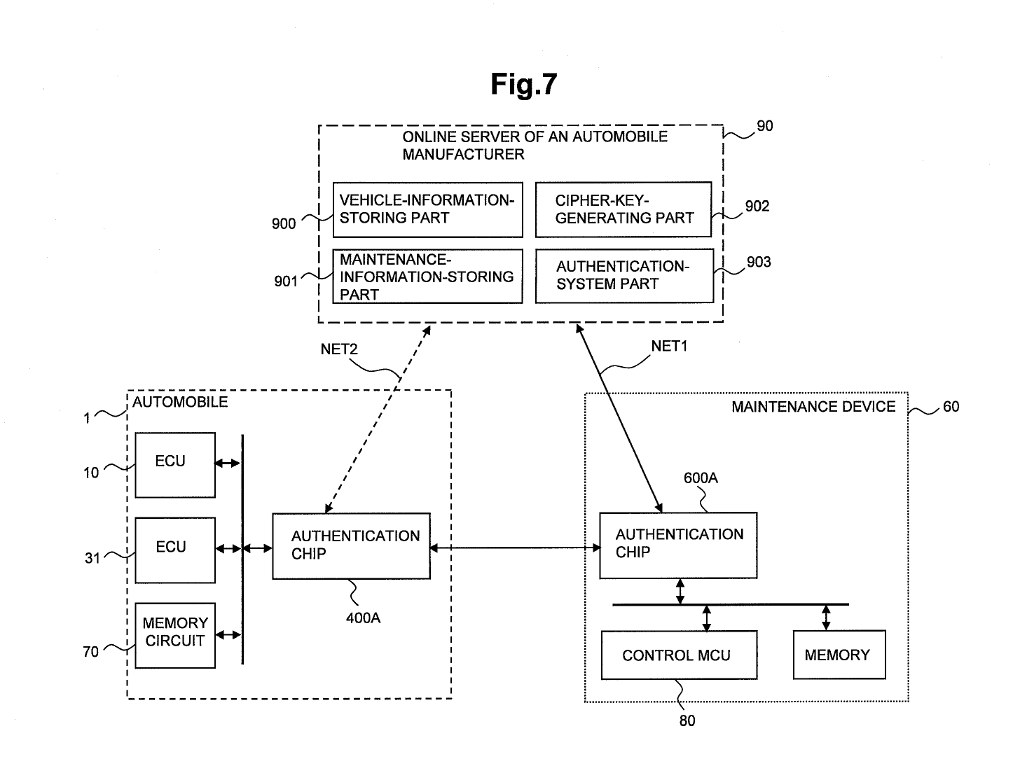

FIG. 7 shows an example of the basic flow of a maintenance service system including a maintenance device and an online server of an automobile manufacturer.

The online server 90 of an automobile manufacturer is for managing the information of maintenance of the automobile, and has a vehicle-information-storing part 900, a maintenance-information-storing part 901, a cipher-key-generating part 902, and an authentication-system part 903. The authentication-system part 903 recognizes an encrypted communication by an authentication chip. The cipher-key-generating part 902 creates an encryption key for the authentication chip 600A. The vehicle-information-storing part 900 stores vehicle information of an automobile targeted for maintenance. The maintenance-information-storing part 901 holds therein and manages maintenance information of a location where the maintenance was performed. The authentication chip 400A of the automobile 1 is different from the authentication chip 400 of FIG. 1 in that it is connected to the online server 90 through an interface circuit 408, whereby the authentication chip 400A can communicate with the online server. The authentication chip 600A of the maintenance device 60 is different from the authentication chip 600 of FIG. 1 in that it is connected to the online server 90 through an interface circuit 608, whereby the authentication chip 600A can communicate with the online server.

The automobile is maintained using the online server 90 on condition that the automobile 1, the maintenance device 60 and the online server 90 have been authenticated as results of the authentication processes between the automobile 1 and maintenance device 60, and between the maintenance device 60 and online server 90, and between the online server 90 and automobile 1. With the above condition satisfied, the maintenance device 60 is allowed to access the maintenance-information-storing part 901 of the online server 90. The automobile restricts a range in which the maintenance device 60 can access the electronic control units 10-31 and memory circuit 70 of the automobile 1, according to the result of the authentication process between the automobile and maintenance device 60. The detail of the restriction is determined by the ID number assigned to the authentication chip 600A of the maintenance device 60, as described above.

The maintenance device 60 is connected to the online server 90 through a network NET1. The automobile 1 can be connected, through another network NET2, to the online server 90. However, the automobile 1 cannot be connected to the network NET2 with a poor radio waves' condition. In some cases, the automobile has no radio interface physically. In case that the automobile 1 cannot be connected to the online server 90 through the network NET2, the automobile 1 can be connected to the network server 90 through the maintenance device 60.

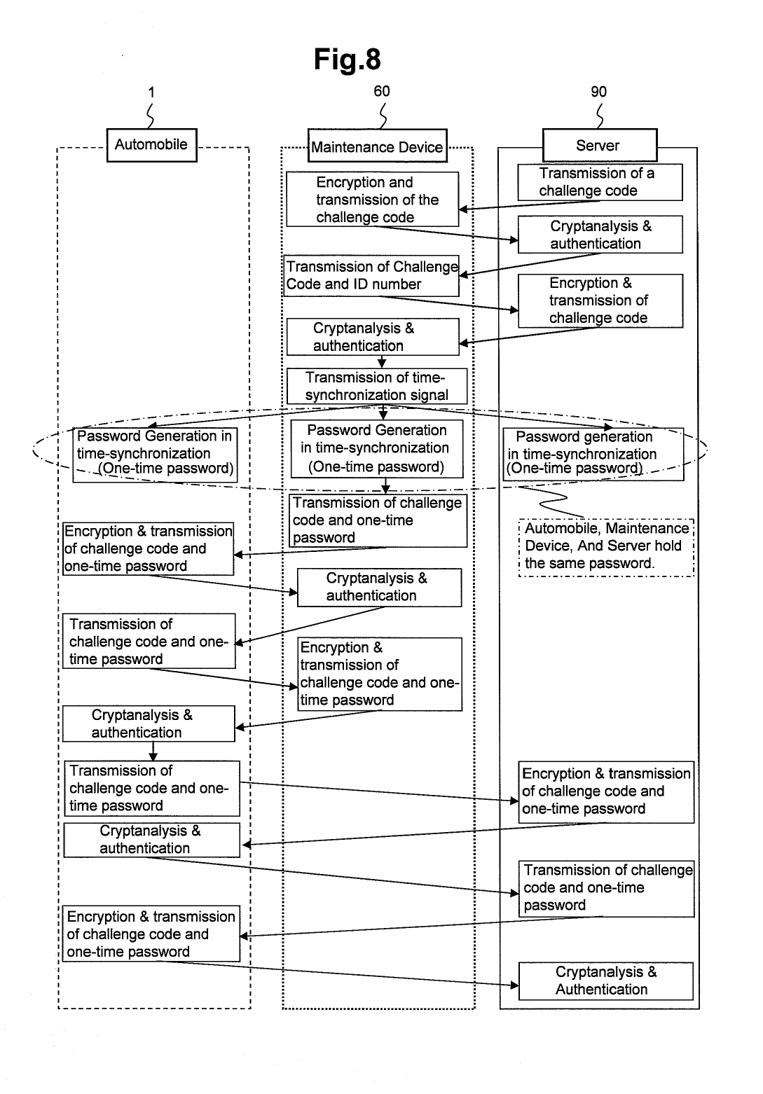

FIG. 8 shows a concrete example of the authentication process in the maintenance service system. First, the authentications of the maintenance device 60 and online server 90 are performed using challenge codes. After the maintenance device 60 and online server 90 have authenticated each other according to the same authentication scheme as described with reference to FIG. 6, the maintenance device 60 transmits a time-synchronization signal. Then, the automobile 1, the maintenance device 60 and the online server 90 create one-time passwords respectively using the same algorithm in time-synchronization with one another. The passwords are created involving the time conception, and therefore they vary each time of creation. In this way, the automobile 1, maintenance device 60 and online server 90 can hold a one-time password common to them. Subsequently, the automobile 1 and maintenance device 60 authenticate each other using the password, according to the same authentication scheme as described with reference to FIG. 6. Then, the automobile 1 and online server 90 authenticate each other according to the same authentication scheme as described with reference to FIG. 6. Thus, it becomes possible to perform mutual authentications among the automobile 1, maintenance device 60 and online server 90.

According to a maintenance service system using a network server, an automobile manufacturer can manage, on its own, a cipher key as well as data concerning the frequency of maintenance, its location, etc. Further, such maintenance service system enables distribution of the cipher key each time of maintenance, and facilitates adaptation to the change of the cipher key. Moreover, it is possible to issue a one-time password. Hence, each automobile manufacturer can manage a repair history, and others collectively, and can increase the ease of maintenance of the automobile.

### <<Example of Incorporating One Authentication Chip in Each ECU>>

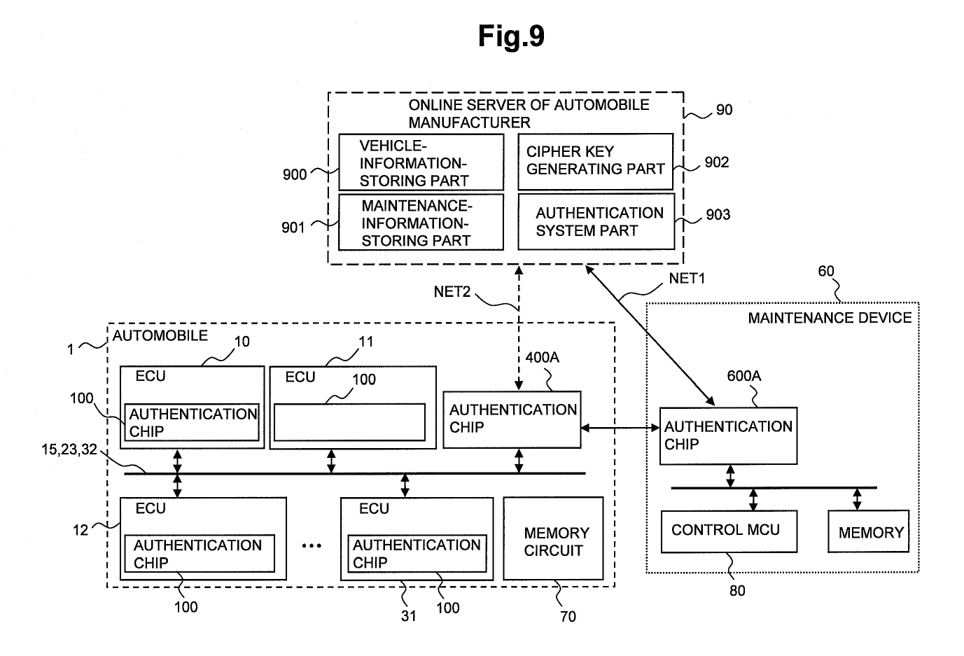

FIG. 9 shows an example where one authentication chip 100 is incorporated in each of ECU 10-14, 20-22 and 30-31 of the automobile. The authentication chip 100 is configured in the same way as the authentication chip 400. The authentication chips 100 and 400 can be connected with one another through on-vehicle networks 15, 23 and 32. The authentication chip 100 is used in judging the validity of ECU.

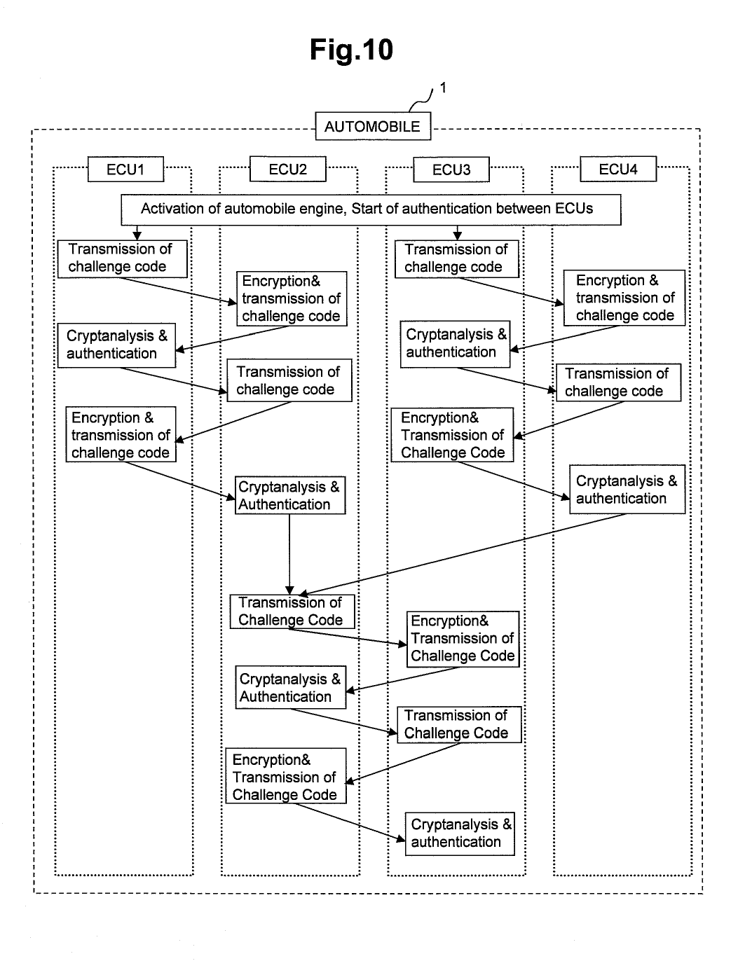

FIG. 10 shows an example of a method of ECU authentication process using the authentication chip of each ECU. Now, the description here is presented on the assumption that the number of ECUs is four, for the sake of simplicity. It is checked whether each ECU is proper one or not at the time of startup of the engine of the automobile 1, i.e. at power-on of operating power of ECUs. As shown in FIG. 10, ECUs start the authentication processes in pairs. Each of the pair of ECU1 and ECU2, and the pair of ECU3 and ECU4, conducts the authentication process on each other in the same way as described with reference to FIG. 6. Next, ECU of the pair, which has finished the mutual authentication earlier, is again paired with ECU of the other pair into another pairs respectively. Then, with the ECU pairs thus formed, the authentication processes are performed in the same way. Thereafter, the same procedure will be repeated, whereby whether all of ECUs are proper ones or not can be checked. In case that an authentication error occurs somewhere, e.g. data of numbers of ECUs involved with the authentication error may be stored therein, followed by displaying an error code, and performing an appropriate action, such as stopping the engine.

The techniques of unauthorized remodeling of ECUs include not only the means for overwriting an ECU program, but also means for substituting another ECU for the existing ECU, and means for adding a sub-ECU to the system thereby to change the system itself. Arranging ECUs each having an authentication chip incorporated therein, a system in which an access between ECUs is performed through the authentication chips thereof can be constructed. With the system so constructed, in case that a change in system, such as the ECU substitution, addition of another ECU or the like is caused, ECU in question is never authenticated and the system cannot be operated. Thus, the remodeling of ECU, which an automobile manufacturer did not intend, can be prevented. In addition, each automobile manufacturer holds a cipher key which is known by only the authorized manufacturers of the authentication chip and automobile having the ID management, and therefore even in case that a trouble or failure occurs in ECU, only the ECU in question can be replaced with another.

While the embodiments of the invention made by the inventor have been described above concretely, the invention is not limited to them. It is obvious that various changes and modifications may be made without departing from the subject matter hereof.

For instance, a structure in which each ECU has its own authentication chip can be also applied to a maintenance service with no network server. In addition, the restrictions on the accessible range may consist of a stage where access is allowed, and a stage where access is rejected, simply. The concrete method of controlling the access restrictions is not limited to the address management as described above. The access execution may be restricted according to the types of commands, such as a read command and a write command.

The invention can be widely applied to maintenance services for various types of vehicles including automobiles, vehicles and maintenance devices themselves.

What is claimed is:

1. A vehicle comprising:
a plurality of electronic control units arranged to electronically control an action of the vehicle;
an on-vehicle network connected with the electronic control units; and
an externally-connecting electronic control unit operable to interface the on-vehicle network to a maintenance device outside the vehicle,
wherein the externally-connecting electronic control unit performs an authenticate process on the maintenance device in order to decide a range in which the maintenance device can access the electronic control units.

2. The vehicle according to claim 1, wherein the externally-connecting electronic control unit has an authentication microcomputer for performing the authentication process, and
the authentication microcomputer performs the authentication process on an authentication microcomputer mounted on the maintenance device.

3. The vehicle according to claim 2, wherein the electronic control units each have an authentication microcomputer, and
the authentication microcomputer mounted on the electronic control unit performs an authentication process on an authentication computer mounted on another electric control unit in order to judge validity thereof.

4. The vehicle according to claim 3, wherein the authentication microcomputers mounted on the electronic control units start the authentication process in response to power-on of operating power.

5. The vehicle according to claim 1, wherein the externally-connecting electronic control unit decides a range of access to be restricted, based on an ID code provided by the maintenance device connected thereto, after having checked validity of the maintenance by the authentication process.

6. The vehicle according to claim 5, further comprising:
a memory for holding a history of maintenance by the maintenance device,
wherein the memory is targeted for control of the access range according to a result of the authentication process.

7. A vehicle comprising:
a plurality of electronic control units arranged to electronically control an action of the vehicle;
an on-vehicle network connected with the electronic control units; and
an externally-connecting electronic control unit operable to interface the on-vehicle network to a maintenance device outside the vehicle,
wherein the externally-connecting electronic control unit has an authentication microcomputer, and
the authentication microcomputer performs an authentication process on the maintenance device in order to decide whether or not to permit the maintenance device to access the electronic control unit.

8. A vehicle comprising:
a plurality of electronic control units arranged to electronically control an action of the vehicle;
an on-vehicle network connected with the electronic control units; and
an externally-connecting electronic control unit for interfacing the on-vehicle network to an external device outside the vehicle,
wherein the externally-connecting electronic control unit performs an authentication process on the external device outside the vehicle in order to decide whether or not to permit the external device to access the electronic control unit.

9. A maintenance device for supporting maintenance of a vehicle having a plurality of electronic control units operable to electrically control an action of the vehicle, comprising:
an authentication microcomputer connectable with an externally-connecting electronic control unit of the vehicle; and
a microcomputer operable to control the maintenance support,
wherein the authentication microcomputer and the externally-connecting electronic control unit connected therewith perform an authentication process on each other, and
a range in which the microcomputer operable to control the maintenance support can access the electronic control unit of the vehicle is decided according to a result of the authentication process by the externally-connecting electronic control unit.

10. The maintenance device according to claim 9, wherein the authentication microcomputer sends a result of a judgment on validity of the vehicle connected therewith to the microcomputer operable to control the maintenance support.

11. A maintenance service system, comprising:
a maintenance device for supporting maintenance of a vehicle having a plurality of electronic control units operable to electrically control an action of the vehicle; and
an online server operable to manage maintenance information of the vehicle,
wherein the maintenance device is allowed to access maintenance information in the online server on condition that the vehicle, maintenance device and online server have been authenticated as results of authentication processes between the vehicle and maintenance device, between the maintenance device and online server, and between the online server and vehicle, and
a range in which the maintenance device can access the electronic control unit of the vehicle is decided according to a result of the authentication process between the vehicle and maintenance device.

12. The maintenance service system according to claim 11, wherein the maintenance device has an authentication microcomputer for performing a mutual authentication process between the maintenance device and online server,
the online server is paired with an authentication microcomputer of the vehicle, and the online server and authentication microcomputer perform an authentication process on each other, and
the authentication microcomputer of the maintenance device is paired with the authentication microcomputer of the vehicle, and the authentication microcomputers perform an authentication process on each other.

13. A vehicle maintenance service method, using a maintenance device for supporting maintenance of a vehicle having a plurality of electronic control units operable to electrically control an action of the vehicle, and an online server operable to manage maintenance information of the vehicle, comprising:
a first step of performing an authentication process between the vehicle and maintenance device;
a second step of performing an authentication process between the maintenance device and online server;
a third step of performing an authentication process between the online server and vehicle;
a fourth step of accessing maintenance information of the online server by the maintenance device on condition that the vehicle, maintenance device, and online server have been authenticated as results of the first to third steps; and
a fifth step of accessing the electronic control unit of the vehicle by the maintenance device in a range determined according to a result of the authentication process between the maintenance device and vehicle.

14. The maintenance service method according to claim 13, wherein the maintenance device includes an authentication microcomputer for performing a mutual authentication process between the maintenance device and online server,
the online server performs an authentication process between the online server and an authentication microcomputer mounted on the automobile, and
the authentication microcomputer of the maintenance device performs an authentication process between the authentication microcomputer of the maintenance device and the authentication microcomputer mounted on the automobile.
